(19) United States
(12) Patent Application Publication
(10) Pub. No.: US 2018/0260705 A1
(43) Pub. Date: Sep. 13, 2018

(54) SYSTEM AND METHOD FOR APPLYING TRANSFER LEARNING TO IDENTIFICATION OF USER ACTIONS

(71) Applicant: Verint Systems Ltd., Herzliya Pituach (IL)

(72) Inventors: Rami Puzis, Ashdod (IL); Asaf Shabtai, Hulda (IL); Gershon Celniker, Tel Aviv (IL); Liron Rosenfeld, Herzelia (IL); Ziv Katzir, Even Yehuda (IL); Edita Grolman, Ashdod (IL)

(21) Appl. No.: 15/911,223

(22) Filed: Mar. 5, 2018

(30) Foreign Application Priority Data
Mar. 5, 2017 (IL) 250948

(51) Int. Cl. G06N 3/08; G06N 3/04

(52) U.S. Cl. CPC G06N 3/08; G06N 3/0454

(57) ABSTRACT

Methods and systems for analyzing encrypted traffic, such as to identify, or “classify,” the user actions that generated the traffic. Such classification is performed, even without decrypting the traffic, based on features of the traffic. Such features may include statistical properties of (i) the times at which the packets in the traffic were received, (ii) the sizes of the packets, and/or (iii) the directionality of the packets. To classify the user actions, a processor receives the encrypted traffic and ascertains the types (or “classes”) of user actions that generated the traffic. Unsupervised or semi-supervised transfer-learning techniques may be used to perform the classification process. Using transfer-learning techniques facilitates adapting to different runtime environments, and to changes in the patterns of traffic generated in these runtime environments, without requiring the large amount of time and resources involved in conventional supervised-learning techniques.

### FIELD OF THE DISCLOSURE

The present disclosure is related to the monitoring of encrypted communication over communication networks, and specifically to the application of machine-learning techniques to facilitate such monitoring.

### BACKGROUND OF THE DISCLOSURE

In some cases, marketing personnel may wish to learn more about users' online behavior, in order to provide each user with relevant marketing material that is tailored to the user's behavioral and demographic profile. A challenge in doing so, however, is that many applications use encrypted protocols, such that the traffic exchanged by these applications is encrypted. Examples of such applications include Gmail, Facebook, and Twitter. Examples of encrypted protocols include the Secure Sockets Layer (SSL) protocol and the Transport Layer Security (TLS) protocol.

Conti, Mauro, et al. “Can't you hear me knocking: Identification of user actions on Android apps via traffic analysis,” Proceedings of the 5th ACM Conference on Data and Application Security and Privacy, A C M, 2015, which is incorporated herein by reference, describes an investigation as to which extent it is feasible to identify the specific actions that a user is performing on mobile apps, by eavesdropping on their encrypted network traffic.

Saltaformaggio, Brendan, et al. “Eavesdropping on fine-grained user activities within smartphone apps over encrypted network traffic,” Proc. USENIX Workshop on Offensive Technologies, 2016, which is incorporated herein by reference, demonstrates that a passive eavesdropper is capable of identifying fine-grained user activities within the wireless network traffic generated by apps. The paper presents a technique, called NetScope, that is based on the intuition that the highly specific implementation of each app leaves a fingerprint on its traffic behavior (e.g., transfer rates, packet exchanges, and data movement). By learning the subtle traffic behavioral differences between activities (e.g., “browsing” versus “chatting” in a dating app), NetScope is able to perform robust inference of users' activities, for both Android and iOS devices, based solely on inspecting IP headers.

### SUMMARY OF THE DISCLOSURE

There is provided, in accordance with some embodiments of the present disclosure, a system that includes a network interface and a processor. The processor is configured to receive, via the network interface, encrypted traffic generated responsively to second-environment actions performed, by one or more users on one or more devices, in a second runtime environment. The processor is further configured to train a second classifier, using a first classifier, to classify the second-environment actions based on statistical properties of the traffic, the first classifier being configured to classify first-environment actions, performed in a first runtime environment, based on statistical properties of encrypted traffic generated responsively to the first-environment actions. The processor is further configured to classify the second-environment actions, using the trained second classifier, and to generate an output responsively to the classifying.

In some embodiments, the second runtime environment differs from the first runtime environment by virtue of a computer application used to perform the second-environment actions being different from a computer application used to perform the first-environment actions.

In some embodiments, the second runtime environment differs from the first runtime environment by virtue of an operating system used to perform the second-environment actions being different from an operating system used to perform the first-environment actions.

In some embodiments, the processor is configured to train the second classifier by:

providing, to the first classifier, labeled samples of the traffic generated responsively to the second-environment actions, such that the first classifier classifies the labeled samples based on the statistical properties of the labeled samples, and

training the second classifier to classify the second-environment actions based on the classification performed by the first classifier.

In some embodiments, the processor is configured to use the first classifier by incorporating a portion of the first classifier into the second classifier.

In some embodiments, the first classifier includes a first deep neural network (DNN) and the second classifier includes a second DNN, and the processor is configured to incorporate the portion of the first classifier into the second classifier by incorporating, into the second DNN, one or more neuronal layers of the first DNN.

There is further provided, in accordance with some embodiments of the present disclosure, a system that includes a network interface and a processor. The processor is configured to receive, via the network interface, encrypted traffic generated responsively to a first plurality of actions performed, using a computer application, by one or more users. The processor is further configured to classify the actions, using a classifier, based on statistical properties of the traffic. The processor is further configured to identify, subsequently, that the classifier is misclassifying at least some of the actions that belong to a given class, to automatically label, in response to the identifying, a plurality of traffic samples as corresponding to the given class, and to retrain the classifier, using the labeled samples. The processor is further configured to receive, subsequently, encrypted traffic generated responsively to a second plurality of actions performed using the computer application, to classify the second plurality of actions using the retrained classifier, and to generate an output responsively thereto.

In some embodiments, the classifier includes an ensemble of lower-level classifiers, and the processor is configured to label the traffic samples by providing the traffic samples to the lower-level classifiers, such that one or more of the lower-level classifiers labels the traffic samples as corresponding to the given class.

In some embodiments, the processor is configured to label the traffic samples by:

clustering the traffic samples, along with a plurality of pre-labeled traffic samples that are pre-labeled as corresponding to the given class, into a plurality of clusters, such that at least one of the clusters, which contains at least some of the pre-labeled traffic samples, is labeled as corresponding to the given class, and others of the clusters are unlabeled,

subsequently, identifying those of the unlabeled clusters that are within a given distance from the labeled cluster, and

subsequently, labeling those of the samples that belong to the identified clusters as corresponding to the given class.

In some embodiments, the processor is configured to identify that the classifier is misclassifying at least some of the actions that belong to the given class by identifying that one or more statistics, associated with a frequency with which the given class is identified, deviate from historical values.

There is further provided, in accordance with some embodiments of the present disclosure, a method that includes receiving, by a processor, encrypted traffic generated responsively to second-environment actions performed, by one or more users on one or more devices, in a second runtime environment. The method further includes training a second classifier, using a first classifier, to classify the second-environment actions based on statistical properties of the traffic, the first classifier being configured to classify first-environment actions, performed in a first runtime environment, based on statistical properties of encrypted traffic generated responsively to the first-environment actions. The method further includes classifying the second-environment actions, using the trained second classifier, and generating an output responsively to the classifying.

There is further provided, in accordance with some embodiments of the present disclosure, a method that includes receiving, by a processor, encrypted traffic generated responsively to a first plurality of actions performed, using a computer application, by one or more users. The method further includes classifying the actions, using a classifier, based on statistical properties of the traffic. The method further includes identifying, subsequently, that the classifier is misclassifying at least some of the actions that belong to a given class, automatically labeling, in response to the identifying, a plurality of traffic samples as corresponding to the given class and retraining the classifier, using the labeled samples. The method further includes receiving, subsequently, encrypted traffic generated responsively to a second plurality of actions performed using the computer application, classifying the second plurality of actions using the retrained classifier, and generating an output responsively thereto.

The present disclosure will be more fully understood from the following detailed description of embodiments thereof, taken together with the drawings, in which:

### BRIEF DESCRIPTION OF THE DRAWINGS

FIG. 1 is a schematic illustration of a system for monitoring encrypted communication exchanged over a communication network, such as the Internet, in accordance with some embodiments of the present disclosure;

FIG. 2 schematically shows a method for transferring learning from a first runtime environment to a second runtime environment, in accordance with some embodiments of the present disclosure;

FIG. 3 is a schematic illustration of a technique for training a second classifier by incorporating a portion of a first classifier into the second classifier, in accordance with some embodiments of the present disclosure; and

FIGS. 4A-B are schematic illustrations of methods for automatically labeling a plurality of samples, in accordance with some embodiments of the present disclosure.

### DETAILED DESCRIPTION OF EMBODIMENTS

### Overview

Applications that use encrypted protocols generate encrypted traffic, upon a user using these applications to perform various actions. For example, upon a user performing a “tweet” action using the Twitter application, the Twitter application generates encrypted traffic, which, by virtue of being encrypted, does not explicitly indicate that the traffic was generated in response to a tweet action.

Embodiments of the present disclosure include methods and systems for analyzing such encrypted traffic, such as to identify, or “classify,” the user actions that generated the traffic. Such classification is performed, even without decrypting the traffic, based on features of the traffic. Such features may include statistical properties of (i) the times at which the packets in the traffic were received, (ii) the sizes of the packets, and/or (iii) the directionality of the packets. For example, such features may include the average, maximum, or minimum duration between packets, the average, maximum, or minimum packet size, or the ratio of the number, or total size of, the uplink packets to the number, or total size of, the downlink packets.

To classify the user actions, a processor receives the encrypted traffic, and then, by applying a machine-learned classifier (or “model”) to the traffic, ascertains the types (or “classes”) of user actions that generated the traffic. For example, upon receiving a particular sample (or “observation”) that includes a sequence of packets exchanged with the Twitter application, the processor may ascertain that the sample corresponds to the tweet class of user action, in that the sample was generated in response to a tweet action performed by the user of the application. The processor may therefore apply an appropriate “tweet” label to the sample. (Equivalently, it may be said that the processor classifies the sample as belonging to, or corresponding to, the “tweet” class.)

In the context of the present application, including the claims, a “runtime environment” refers to a set of conditions under which a computer application is used on a device, each of these conditions having an effect on the statistical properties of the traffic that is generated responsively to usage of the application. Examples of such conditions include the application, the version of the application, the operating system on which the application is run, the version of the operating system, and the type and model of the device. Two runtime environments are said to be different from one another if they differ in the statistical properties of the traffic generated in response to actions performed in the runtime environments, due to differences in any one or more of these conditions. Below, for ease of description, a second runtime environment is referred to as another “version” of a first runtime environment, if the differences between the two runtime environments are relatively minor, as is the case, typically, for two versions of an application or operating system. For example, the release of a new version of Facebook for Android, or the release of a new version of Android, may be described as engendering a new version of the Facebook for Android runtime environment. (Alternatively, it may be said that the first runtime environment has “changed.”)

One challenge, in using a machine-learned classifier as described above, is that a separate classifier needs to be trained for each runtime environment of interest. For example, each of the “Facebook for Android,” “Twitter for Android,” and “Facebook for iOS” runtime environments may require the training of a separate classifier. Another challenge is that each of the classifiers needs to be maintained in the face of changes to the runtime environment that occur over time. For example, the release of a new version of the application, or of the operating system on which the application is run, may necessitate a retraining of the classifier for the runtime environment.

One way to overcome the above-described challenges is to apply a conventional supervised learning approach. Per this approach, for each runtime environment of interest, and following each change to the runtime environment that requires a retraining, a large amount of labeled data, referred to as a “training set,” is collected, and a classifier is then trained on the data (i.e., the classifier learns to predict the labels, based on features of the data). This approach, however, is often not feasible, due to the time and resources required to produce a sufficiently large and diverse training set for each case in which such a training set is required.

Embodiments of the present disclosure therefore address both of the above-described challenges by applying, instead of conventional supervised learning techniques, unsupervised or semi-supervised transfer-learning techniques. These transfer-learning techniques, which do not require a large number of manually-labeled samples, may be subdivided into two general classes of techniques, each of which addresses a different respective one of the two challenges noted above. In particular:

(i) Some techniques transfer learning from a first runtime environment to a second runtime environment, thus addressing the first challenge. In other words, these transfer-learning techniques allow a classifier for the second runtime environment to be trained, even if only a small number of labeled samples from the second runtime environment are available.

For example, these techniques may transfer learning, for a particular application, from one operating system to another, capitalizing on the similar way in which the application interacts with the user across different operating systems. In some cases, moreover, these techniques may transfer learning between two different applications, capitalizing on the similarity between the two applications with respect to the manner in which the applications interact with the user. For example, the two applications may belong to the same class of applications, such that each of the applications provides a similar set of user-action types. As an example, each of the first and second applications may belong to the instant-messaging class of applications, such that the two applications both provide message-typing actions and message-sending actions.

As an example of such a transfer-learning technique, each of a small number of labeled samples from a second application may be passed to a first classifier that was trained for a first application. For each of these samples, the first classifier returns a respective probability for each of the classes that the first classifier recognizes. For example, for a sample of type “like” from the Facebook application, a classifier that was trained for the Twitter application may return a 40% probability that the sample is a “tweet,” a 30% probability that the sample is a “retweet,” and a 30% probability that the sample is an “other” type of action. Subsequently, a second classifier, which is “stacked” on top of the first classifier, is trained to classify user actions for the second application, based on the probabilities returned by the first classifier. For example, if “like” actions are on average assigned, by the first classifier, a 40%/30%/30% probability distribution as described above, the second classifier may learn to classify a given sample as a “like” in response to the first classifier returning, for the sample, a probability distribution that is close to 40%/30%/30%.

As another example, a deep neural network (DNN) classifier may be trained for the second application, by making small changes to a DNN classifier that was already trained for the first application. (This technique is particularly effective for transferring learning between two applications that share common patterns of user actions, such as two instant-messaging applications that share a common sequence of user actions for each message that is sent by one party and read by another party.) For example, only the output layer of the DNN (known as a Softmax classifier), which performs the actual classification, may be recalibrated, or replaced with a different type of classifier; the input layer of the DNN, and the hidden layers of the DNN that perform feature extraction, may remain the same. To recalibrate or replace the output layer of the DNN, labeled samples from the second application are passed to the DNN, and the features extracted from these labeled samples are used to train a new Softmax, or other type of, classifier. Due to the similarly between the applications, only a small number of such labeled samples are needed. (Optionally, the weights in the hidden layers of the DNN may also be fine-tuned, by performing a backpropagation method.)

(ii) Other techniques transfer learning between two versions of a runtime environment, thus addressing the second challenge noted above. In other words, these transfer-learning techniques allow a classifier for the runtime environment to be retrained, even if only a small number of pre-labeled samples from the new version of the runtime environment, or no pre-labeled samples from the new version of the runtime environment, are available. These techniques generally capitalize on the similarity, between the two versions of the runtime environment, in the traffic that is generated for any particular user action, along with the similar ways in which the two versions are used.

For example, upon a new version of a particular application being released, the classifier for the application may begin to misclassify at least some instances of a particular user action, due to changes in the manner in which traffic is communicated from the application. (For example, for the Twitter application, some “tweet” actions be erroneously classified as another type of action.) Upon identifying these “false negatives,” and even without necessarily identifying that a new version of the application was released, the classifier may be retrained for the new version of the application.

First, to identify the false negatives, a robotic user may periodically pass traffic, of known user-action types, to the classifier, and the results from the classifier may be examined for the presence of false negatives. Alternatively or additionally, a drop in the confidence level with which a particular type of user action is identified may be taken as an indication of false negatives for that type of user action. Alternatively or additionally, changes in other parameters internal to the classification model (e.g., entropies of a random forest) may indicate the presence of false negatives. Alternatively or additionally, if one or more statistics, associated with the frequency with which a particular class of user action is identified, are seen to deviate from historical values, it may be deduced that the classifier is misclassifying this type of user action. For example, if the average number of times that this type of user action is identified (e.g., on a daily or hourly basis) is less than a historical average, it may be deduced that the classifier is misclassifying this type of user action.

Further to identifying these false negatives, a plurality of samples of the misclassified user-action type (i.e., the user-action type that is being missed by the classifier) may be labeled automatically, and the automatically-labeled samples may then be used to retrain the classifier. These automatically-labeled samples may be augmented with labeled samples from the above-described robotic user.

For example, for a classifier that includes an ensemble of lower-level classifiers, a large number of unlabeled samples, which will necessarily include instances of the misclassified user-action type, may be passed to each of the lower-level classifiers. Subsequently, samples that are labeled as corresponding to the misclassified user-action type, with a high level of confidence, by at least one of the lower-level classifiers, are taken as new “ground truth,” and are used to retrain the classifier.

Alternatively, a mix of (i) a small number of pre-labeled samples, labeled as corresponding to the misclassified user-action type, and (ii) unlabeled samples, may be clustered into a plurality of clusters, based on features of the samples. Subsequently, any unlabeled samples belonging to a cluster that is close enough to a cluster of labeled samples may be labeled as corresponding to the misclassified user-action type. These newly-labeled samples may then be used to retrain the classifier.

In summary, embodiments described herein, by using transfer-learning techniques, facilitate adapting to different runtime environments, and to changes in the patterns of traffic generated in these runtime environments, without requiring the large amount of time and resources involved in conventional supervised-learning techniques.

### System Description

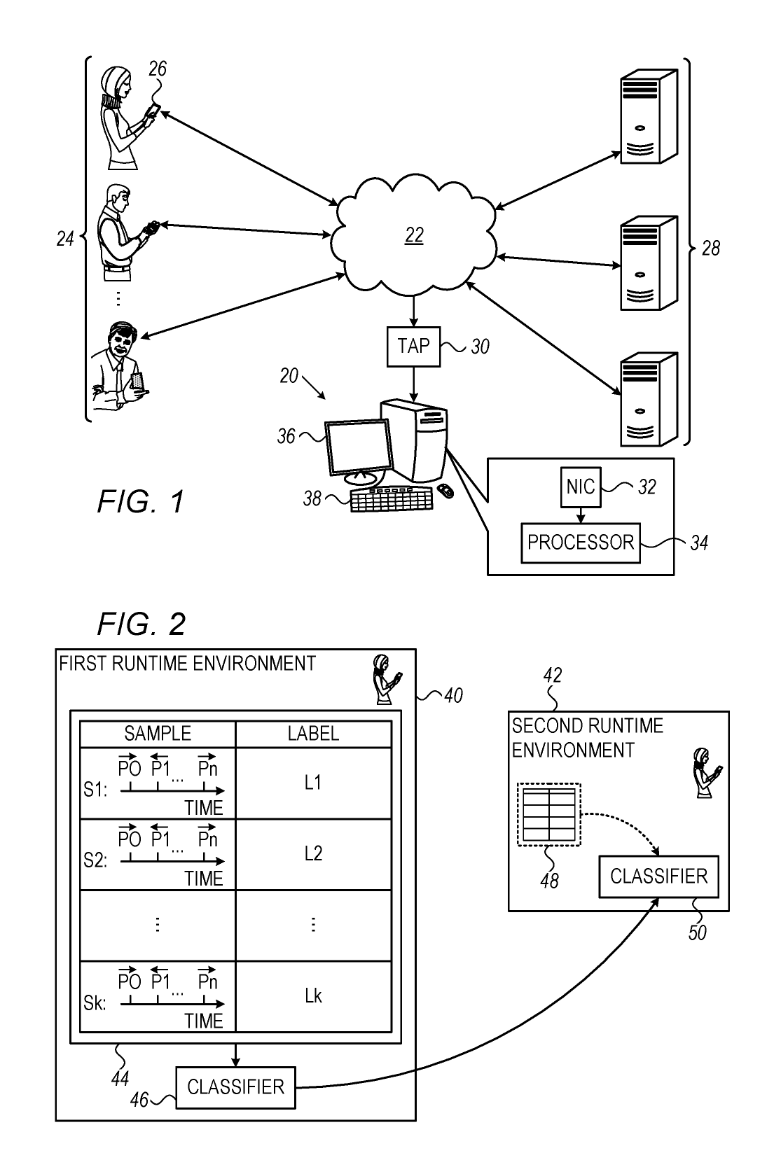

Reference is initially made to FIG. 1, which is a schematic illustration of a system 20 for monitoring encrypted communication exchanged over a communication network 22, such as the Internet, in accordance with some embodiments of the present disclosure. System 20 comprises a network interface 32, such as a network interface controller (NIC), and a processor 34.

FIG. 1 depicts a plurality of users 24 using various computer applications that run on respective devices 26 belonging to users 24. Devices 26 may include, for example, mobile devices, such as the smartphones shown in FIG. 1, or any other devices configured to execute computer applications. Each of the applications communicates with a respective server 28. (In some cases, a plurality of applications may share a common server.) By interacting with the respective user interfaces of the applications (e.g., by entering text into designated fields, or hitting buttons, defined in a graphical user interface), the users perform various actions, which cause encrypted traffic to be exchanged between the applications and servers 28. A network tap 30 receives this traffic from network 22, and passes the traffic to system 20. The encrypted traffic is received, via network interface 32, by processor 34. As described in detail below, processor 34 then analyzes the encrypted traffic, such as to identify the user actions that generated the encrypted traffic.

In some embodiments, system 20 further comprises a display 36, configured to display any results of the analysis performed by processor 34. System 20 may further comprise one or more input devices 38, which allow a user of system 20 to provide relevant input to processor 34, and/or a computer memory, in which relevant results may be stored by processor 34.

In some embodiments, processor 34 is implemented solely in hardware, e.g., using one or more general-purpose computing on graphics processing units (GPGPUs) or field-programmable gate arrays (FPGAs). In other embodiments, processor 34 is at least partly implemented in software. For example, processor 34 may be embodied as a programmed digital computing device comprising a central processing unit (CPU), random access memory (RAM), non-volatile secondary storage, such as a hard drive or CD ROM drive, network interfaces, and/or peripheral devices. Program code, including software programs, and/or data are loaded into the RAM for execution and processing by the CPU, and results are generated for display, output, transmittal, or storage, as is known in the art. The program code and/or data may be downloaded to the processor in electronic form, over a network, for example, or it may, alternatively or additionally, be provided and/or stored on non-transitory tangible media, such as magnetic, optical, or electronic memory. Such program code and/or data, when provided to the processor, produce a machine or special-purpose computer, configured to perform the tasks described herein.

In general, processor 34 may be embodied as a single processor, or as a cooperatively networked or clustered set of processors. As an example of the latter, processor 34 may be embodied as a cooperatively networked set of three processors, a first one of which performs the transfer-learning techniques described herein, a second one of which uses the classifiers trained by the first processor to classify user actions, and a third one of which generates output, and/or performs further analyses, responsively to the classified user actions. System 20 may comprise, in addition to network interface 32, any other suitable hardware, such as networking hardware and/or shared storage devices, configured to facilitate the operation of such a networked set of processors. The various components of system 20, including any processors, networking hardware, and/or shared storage devices, may be connected to each other in any suitable configuration.

### Transferring Learning Between Runtime Environments

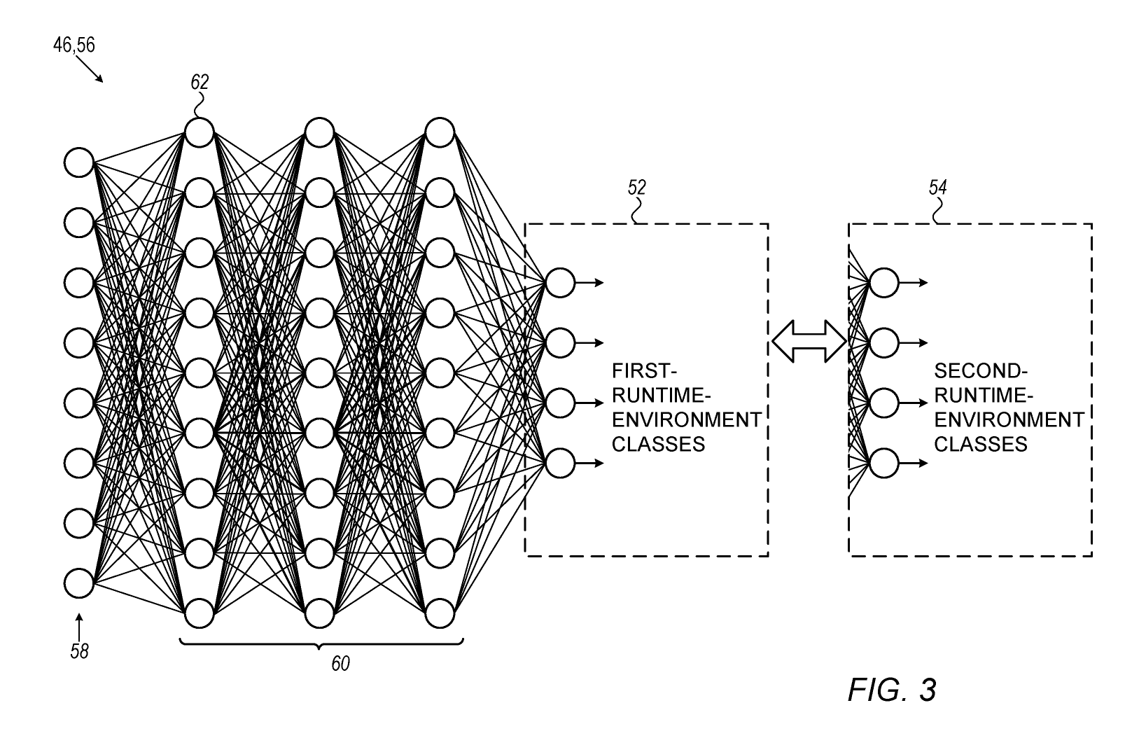

Reference is now made to FIG. 2, which schematically shows a method for transferring learning from a first runtime environment 40 to a second runtime environment 42, in accordance with some embodiments of the present disclosure. As depicted in FIG. 2, processor 34 (FIG. 1) may utilize a first classifier 46 that was already trained for first runtime environment 40, in order to quickly and automatically (or almost automatically) train a second classifier 50 for second runtime environment 42.

First, for first runtime environment 40, processor 34 (or another processor) trains first classifier 46. Typically, the first classifier is trained by a supervised learning technique, whereby the classifier is trained on a large and diverse first training set 44, comprising a plurality of samples {S1, S2, . . . Sk} having corresponding labels {L1, L2, . . . Lk}. Typically, each of these labeled samples includes a sequence of packets generated in response to a particular user action, and the label indicates the class of the user action (such as “post,” “like,” “send,” etc.). For example, each of the labeled samples in FIG. 2 is shown to include a sequence of packets {P0, P1, . . . Pn}, some of these packets being uplink packets, as indicated by the rightward-pointing arrows above the packet indicators, and others of these packets being downlink packets, as indicated by the leftward-pointing arrows. (Although, for simplicity, each of the samples is depicted by the same generic sequence of n packets, it is noted that the samples typically differ from each other with respect to the number of packets and times between the packets, in addition to differing from each other in the sizes and content of the packets.)

Given training set 44, first classifier 46 learns to classify actions performed in the first runtime environment, based on statistical properties of the encrypted traffic generated responsively to these actions. In general, the term “statistical property,” as used in the context of the present specification (including the claims), includes, within its scope, any property of the traffic that may be identified without identifying the actual content of the traffic. For example, as described above in the Overview, a statistical property of a sample of traffic may include the average, maximum, or minimum duration between packets in the sample, the average, maximum, or minimum packet size in the sample, or the ratio of the number, or total size of, the uplink packets in the sample to the number, or total size of, the downlink packets in the sample.

Subsequently, processor 34 trains second classifier 50 to classify actions performed in the second runtime environment, based on statistical properties of the traffic generated responsively to these actions. Advantageously, to this end, the processor uses first classifier 46, such that the training of second classifier 50 may be performed quickly and automatically. In particular, it may not be necessary to provide a labeled training set for training second classifier 50; rather, the training of second classifier 50 may be fully automatic. This is indicated in FIG. 2, by virtue of a second training set 48 having a broken outline, indicating that second training set 48 may not be necessary. Moreover, even if second training set 48 is used, second training set 48 may have much fewer samples than first training set 44.

Subsequently, as described above with reference to FIG. 1, processor 34 receives encrypted traffic via network interface 32, and then classifies the actions performed in the second runtime environment, using the trained second classifier. The processor further generates an output responsively to the classifying. For example, the processor may display a message that indicates the class of each action. Alternatively or additionally, the processor may store a record of the action, in memory, in association with a label that indicates the class of the action. Alternatively or additionally, the processor may update a profile of the user that performed the action, and/or display such a profile. Such a profile may be used, for example, by marketing personnel, to tailor a particular marketing effort to the user.

The following two sections of the specification explain two example techniques by which first classifier 46 may be used to train second classifier 50.

### Stacked Classifiers

In some embodiments, the second classifier is “stacked” on top of first classifier 46, in that the second classifier is trained to classify user actions based on the classification of these actions that is performed by the first classifier. This stacked classifier method may be used, for example, to transfer learning from one application to another.

First, the first classifier is given samples of traffic from second training set 48, such that the first classifier classifies the samples based on statistical properties of the samples. (Since the first classifier operates in the first runtime environment, rather than the second runtime environment, the first classifier will likely misclassify at least some of these samples, and may, in some cases, misclassify all of these samples.) Next, the classification results from the first classifier, along with the labels of the samples, are passed to the second classifier. The second classifier may then find a differentiating pattern within the classification results, and, based on this pattern, learn to classify any particular user action, based on the manner in which this action was classified—correctly or otherwise—by the first classifier.

For example, the first classifier may classify a given action by first calculating a respective probability that the action belongs to each of the classes that the first classifier recognizes, and then associating the action with the class having the highest probability. For example, for the Facebook application, the first classifier may classify a particular action as a “post” with 60% probability, as a “like” with 20% probability, and as an “other” with 20% probability. The classifier may then associate the action with the “post” class, based on the “post” class having the highest probability—namely, 60%. In such cases, the second classifier may discover a differentiating pattern in the probability distribution calculated by the first classifier, in that the probability distribution indicates the class of the action.

By way of example, it will be assumed that the first classifier classifies each first-runtime-environment action as belonging to one of two classes SC1 and SC2, by first calculating a probability for each of classes SC1 and SC2, and then selecting the class having the higher probability. It will further be assumed that it is desired to train the second classifier to classify each second-runtime-environment action as belonging to one of three classes TC1, TC2, and TC3. For such a scenario, Table 1, below, shows some hypothetical probabilities that the first classifier might calculate, on average, for a plurality of labeled second-runtime-environment samples. Each row in Table 1 corresponds to a different one of the second-runtime-environment classes, and shows, for each of the first-runtime-environment classes, the average probability that the labeled samples of the second-runtime-environment class belong to the first-runtime-environment class, as calculated by the first classifier. For example, the top-left entry in Table 1 indicates that on average, the labeled samples of class TC1 were assigned, by the first classifier, an 80% chance of belonging to class SC1.

TABLE 1

| | SC1 | SC2 |
|---|---|---|
| TC1 | 0.8 | 0.2 |
| TC2 | 0.3 | 0.7 |
| TC3 | 0.6 | 0.4 |

Given that Table 1 shows a different probability distribution for each of the three second-runtime-environment classes, the second classifier may learn to classify second-runtime-environment actions, based on the probability distributions calculated by the first classifier. For example, if the first classifier calculates, for a given second-runtime-environment action, a probability distribution of 85% (SC1) and 15% (SC2), the second classifier may classify the action as belonging to class TC1, given that the 85%/15% distribution is closer to the 80%/20% distribution of TC1 than to any other one of the probability distributions.

### Incorporation of the First Classifier

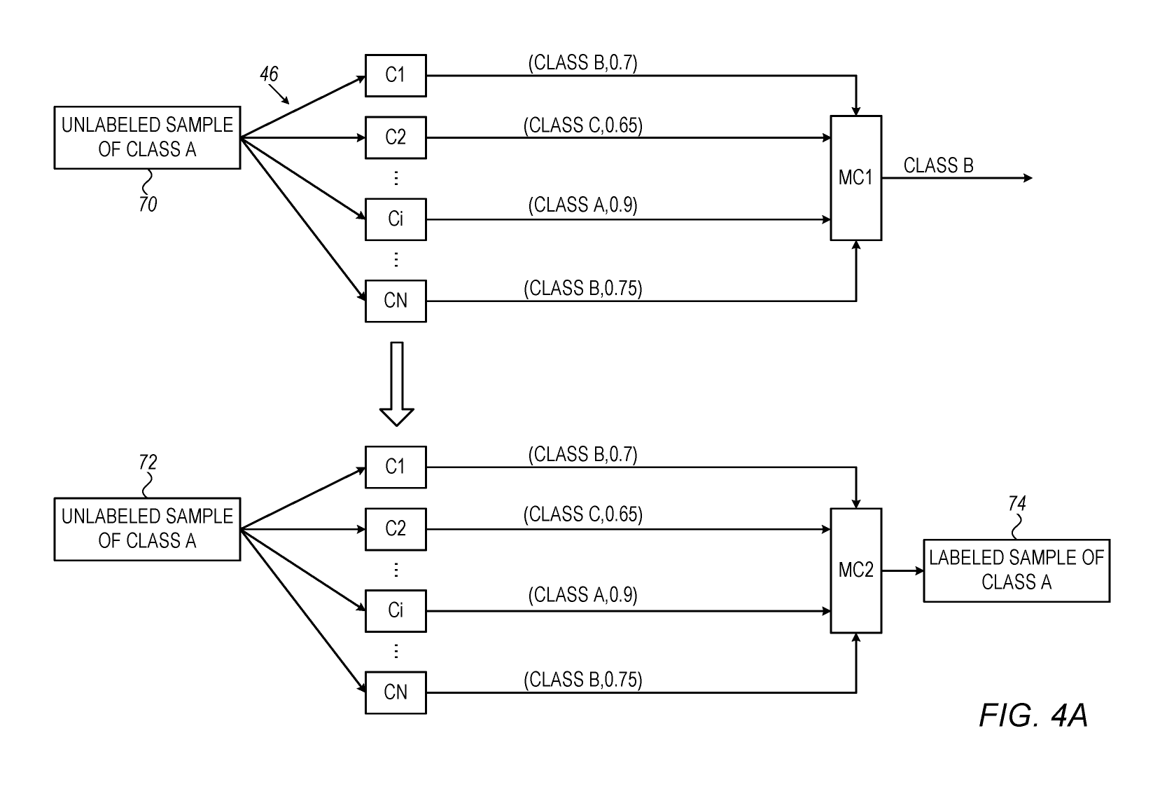

Reference is now made to FIG. 3, which is a schematic illustration of a technique for training a second classifier by incorporating a portion of the first classifier into the second classifier, in accordance with some embodiments of the present disclosure. In effect, the technique illustrated in FIG. 3 transfers part (e.g., most) of first classifier 46 into the second runtime environment, such that little additional learning is required in the second runtime environment.

In the particular example shown in FIG. 3, the first classifier includes a first deep neural network (DNN) 56, which includes a plurality of neuronal layers, including an input layer 58, one or more (e.g., three) hidden layers 60, and an output layer 52. Each neuron 62 that follows input layer 58 is a weighted function of one or more neurons 62 in the preceding layer. In the example shown in FIG. 3, output layer 52 is a Softmax classifier, in that each of the neurons in output layer 52 corresponds to a different respective one of the first-runtime-environment classes. Upon a particular sample, generated in response to a user action, being passed through DNN 56, each of the neurons in output layer 52 outputs a quantity that indicates the likelihood that the user action belongs to the class to which the neuron corresponds.

Given first DNN 56, and provided that the second runtime environment is sufficiently similar to the first runtime environment, the processor may assume that the features used for classification in the first runtime environment are useful for classification also in the second runtime environment, such that all layers of the first DNN, up to output layer 52, may be incorporated into the second DNN. Subsequently, a second output layer 54, comprising a Softmax classifier for the second runtime environment, may be trained, using a small number of labeled second-runtime-environment samples. (In other words, output layer 52 may be “recalibrated,” such that output layer 52 becomes second output layer 54.) Alternatively, output layer 52 may be replaced by another type of classifier, such as a random-forest classifier. In any case, following this procedure, the second DNN may be identical to the first DNN, except for second output layer 54, or another suitable classifier, replacing first output layer 52. (Optionally, the weights in the hidden layers of the DNN may also be fine-tuned, by performing a backpropagation method.)

Analogously to the above, for cases in which classifier 46 includes another type of classifier (e.g., a random forest) in place of output layer 52, this other type of classifier may be replaced with a new classifier of the same, or of a different, type, without changing the input and hidden layers of the DNN.

More generally, it is noted that the scope of the present disclosure includes incorporating any one or more neuronal layers of the first DNN into the second DNN, to facilitate training of the second classifier.

### Automatic Labeling and Classifier Retraining

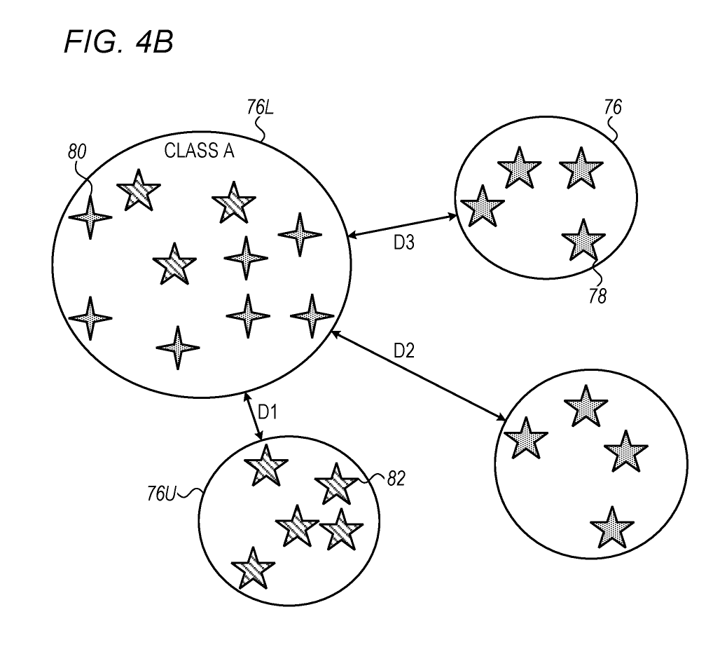

Reference is now made to FIGS. 4A-B, which are schematic illustrations of methods for automatically labeling a plurality of samples, in accordance with some embodiments of the present disclosure.

Each of FIGS. 4A-B pertains to a scenario in which processor 34 has identified, using any of the techniques described above in the Overview, that the classifier used for classifying user actions (in any given runtime environment) is misclassifying user actions belonging to a given “class A.” Each of FIGS. 4A-B shows a different respective method by which the processor may, in response to identifying these false negatives, automatically label a plurality of samples of “class A,” such that these labeled samples may be used to retrain the classifier. Advantageously, the methods of FIGS. 4A-B require little, or no, manually-labeled samples of class A.

In FIG. 4A, first classifier 46 includes an ensemble of N lower-level classifiers {C1, C2, . . . CN}. Given an unlabeled sample, each of these lower-level classifiers classifies the sample with a particular level of confidence. For example, given the unlabeled sample, each of the lower-level classifiers may output the class to which the lower-level classifier believes the sample belongs, along with a probability that the sample belongs to this class, this probability reflecting the lower-level classifier's level of confidence in the classification. A higher-level classifier, or “meta-classifier,” MC1 then combines the individual outputs from the lower-level classifiers, such as to yield a final classification, which may also be accompanied by an associated probability or other measure of confidence.

The top half of FIG. 4A illustrates a scenario in which, due to changes in the runtime environment for which the classifier was trained, classifier 46 is misclassifying an unlabeled sample 70 belonging to class A. In particular, several of the lower-level classifiers are misclassifying sample 70, causing meta-classifier MC1 to incorrectly classify sample 70 as belonging to a different class B. For example, lower-level classifier C1 is classifying sample 70 as belonging to class B, with a probability of 70%. Similarly, it is assumed that several other lower-level classifiers (including lower-level classifier CN) are misclassifying sample 70, such that, even though one of the lower-level classifiers Ci is correctly classifying sample 70, Ci is being outweighed by the other lower-level classifiers.

In response to the processor identifying that classifier 46 is misclassifying samples of class A (such as sample 70), the processor provides, to each of the lower-level classifiers, unlabeled samples of traffic. The processor further applies a second meta-classifier MC2, which operates differently from meta-classifier MC1, to the outputs from the lower-level classifiers. In particular, for each sample, second meta-classifier MC2 checks whether one or more of the lower-level classifiers classified the sample as belonging to class A. If yes, second meta-classifier MC2 may label the sample as belonging to class A.

The bottom half of FIG. 4A illustrates this technique, for an unlabeled sample 72 belonging to class A. As for unlabeled sample 70, several of the lower-level classifiers are misclassifying sample 72. However, instead of allowing these mistaken lower-level classifiers to outweigh lower-level classifier Ci, second meta-classifier MC2 identifies the high level of confidence (reflected in the probability of 90%) with which the classification by lower-level classifier Ci was performed, and therefore labels sample 72 as belonging to class A, thus yielding a new labeled sample 74. This automatically-labeled sample, along with any other samples similarly automatically labeled, may then be used to retrain classifier 46. The retrained classifier may then be used to classify samples of subsequently-received traffic, and/or to reclassify previously-received traffic.

In general, any suitable algorithm may be used to ascertain whether a given sample should be labeled as belonging to class A. For example, the level of confidence output by each lower-level classifier that returned “class A” may be compared to a threshold. If one or more of these levels of confidence exceeds the threshold, the sample may be labeled as belonging to class A. (Such a threshold may be a predefined value, such as 80%, that is the same for all of the samples. Alternatively, the threshold may be set separately for each sample, based on the levels of confidence that are returned by the lower-level classifiers.) Alternatively, any suitable function may be used to combine the respective decisions of the lower-level classifiers; in other words, a voting system may be used. For example, the sample may be labeled as belonging to class A if a certain percentage of the lower-level classifiers returned “class A,” and/or if the combined level of confidence of these lower-level classifiers exceeds a threshold.

In FIG. 4B, a different technique is used to automatically label samples of class A. Per this technique, the processor first collects a plurality of samples of traffic, including both unlabeled samples 78, and a small number of pre-labeled samples 80 that are labeled as belonging to class A. The processor then, based on features of the samples, clusters the samples, in some multidimensional feature space, into a plurality of clusters 76. (To perform this clustering, the processor may use any suitable technique known in the art, such as k-means.) Further to this clustering, at least one cluster 76L, containing pre-labeled samples 80, is labeled as corresponding to class A, while the other clusters are unlabeled, due to these clusters not containing a sufficient number of labeled samples.

Subsequently, the processor calculates the distance between labeled cluster 76L and each of the other clusters. For example, FIG. 4B shows respective distances D1, D2, and D3 between labeled cluster 76L and the unlabeled clusters. The processor then identifies those of the unlabeled clusters that are within a given distance from one of the labeled clusters. For example, given the scenario in FIG. 4B, the processor may compare each of D1, D2, and D3 to a suitable threshold, and may identify only one unlabeled cluster 76U as being sufficiently close to labeled cluster 76L, based on only D1 being less than the threshold. Subsequently, the processor labels any unlabeled samples belonging to the identified clusters—along with any unlabeled samples belonging to labeled cluster 76L—as corresponding to the given class of user action, such that a plurality of newly-labeled samples 82 are obtained. Subsequently, the processor retrains the classifier, using both pre-labeled samples 80 and newly-labeled samples 82.

In other embodiments, the processor maps the samples to the multi-dimensional feature space, but does not perform any clustering. Instead, the processor computes the distance between each unlabeled sample and the nearest pre-labeled sample. Those unlabeled samples that are within a given threshold distance of the nearest pre-labeled sample are then labeled as belonging to the given class.

It is noted that the techniques illustrated in FIGS. 4A-B are provided by way of example only. The scope of the present disclosure includes any suitable technique for automatically labeling samples, and subsequently using these samples to retrain a classifier.

It will be appreciated by persons skilled in the art that the present invention is not limited to what has been particularly shown and described hereinabove. Rather, the scope of embodiments of the present invention includes both combinations and subcombinations of the various features described hereinabove, as well as variations and modifications thereof that are not in the prior art, which would occur to persons skilled in the art upon reading the foregoing description. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A system, comprising:
a network interface; and
a processor, configured:
to receive, via the network interface, encrypted traffic generated responsively to second-environment actions performed, by one or more users on one or more devices, in a second runtime environment;
to train a second classifier, using a first classifier, to classify the second-environment actions based on statistical properties of the traffic,
the first classifier being configured to classify first-environment actions, performed in a first runtime environment, based on statistical properties of encrypted traffic generated responsively to the first-environment actions;
to classify the second-environment actions, using the trained second classifier; and
to generate an output responsively to the classifying.

2. The system according to claim 1, wherein the second runtime environment differs from the first runtime environment by virtue of a computer application used to perform the second-environment actions being different from a computer application used to perform the first-environment actions.

3. The system according to claim 1, wherein the second runtime environment differs from the first runtime environment by virtue of an operating system used to perform the second-environment actions being different from an operating system used to perform the first-environment actions.

4. The system according to claim 1, wherein the processor is configured to train the second classifier by:
providing, to the first classifier, labeled samples of the traffic generated responsively to the second-environment actions, such that the first classifier classifies the labeled samples based on the statistical properties of the labeled samples, and
training the second classifier to classify the second-environment actions based on the classification performed by the first classifier.

5. The system according to claim 1, wherein the processor is configured to use the first classifier by incorporating a portion of the first classifier into the second classifier.

6. The system according to claim 5, wherein the first classifier includes a first deep neural network (DNN) and the second classifier includes a second DNN, and wherein the processor is configured to incorporate the portion of the first classifier into the second classifier by incorporating, into the second DNN, one or more neuronal layers of the first DNN.

7. A system, comprising:
a network interface; and
a processor, configured:
to receive, via the network interface, encrypted traffic generated responsively to a first plurality of actions performed, using a computer application, by one or more users;
to classify the actions, using a classifier, based on statistical properties of the traffic;
to identify, subsequently, that the classifier is misclassifying at least some of the actions that belong to a given class;
to automatically label, in response to the identifying, a plurality of traffic samples as corresponding to the given class;
to retrain the classifier, using the labeled samples;
to receive, subsequently, encrypted traffic generated responsively to a second plurality of actions performed using the computer application;
to classify the second plurality of actions, using the retrained classifier; and
to generate an output responsively thereto.

8. The system according to claim 7, wherein the classifier includes an ensemble of lower-level classifiers, and wherein the processor is configured to label the traffic samples by providing the traffic samples to the lower-level classifiers, such that one or more of the lower-level classifiers labels the traffic samples as corresponding to the given class.

9. The system according to claim 7, wherein the processor is configured to label the traffic samples by:
clustering the traffic samples, along with a plurality of pre-labeled traffic samples that are labeled as corresponding to the given class, into a plurality of clusters, such that at least one of the clusters, which contains at least some of the pre-labeled traffic samples, is labeled as corresponding to the given class, and others of the clusters are unlabeled,
subsequently, identifying those of the unlabeled clusters that are within a given distance from the labeled cluster, and
subsequently, labeling those of the samples that belong to the identified clusters as corresponding to the given class.

10. The system according to claim 7, wherein the processor is configured to identify that the classifier is misclassifying at least some of the actions that belong to the given class by identifying that one or more statistics, associated with a frequency with which the given class is identified, deviate from historical values.

11. A method, comprising:
receiving, by a processor, encrypted traffic generated responsively to second-environment actions performed, by one or more users on one or more devices, in a second runtime environment;
training a second classifier, using a first classifier, to classify the second-environment actions based on statistical properties of the traffic,
the first classifier being configured to classify first-environment actions, performed in a first runtime environment, based on statistical properties of encrypted traffic generated responsively to the first-environment actions;
classifying the second-environment actions, using the trained second classifier; and
generating an output responsively to the classifying.

12. The method according to claim 11, wherein the second runtime environment differs from the first runtime environment by virtue of a computer application used to perform the second-environment actions being different from a computer application used to perform the first-environment actions.

13. The method according to claim 11, wherein the second runtime environment differs from the first runtime environment by virtue of an operating system used to perform the second-environment actions being different from an operating system used to perform the first-environment actions.

14. The method according to claim 11, wherein training the second classifier comprises:
providing, to the first classifier, labeled samples of the traffic generated responsively to the second-environment actions, such that the first classifier classifies the labeled samples based on the statistical properties of the labeled samples, and
training the second classifier to classify the second-environment actions based on the classification performed by the first classifier.

15. The method according to claim 11, wherein using the first classifier comprises using the first classifier by incorporating a portion of the first classifier into the second classifier.

16. The method according to claim 15, wherein the first classifier includes a first deep neural network (DNN) and the second classifier includes a second DNN, and wherein incorporating the portion of the first classifier into the second classifier comprises incorporating, into the second DNN, one or more neuronal layers of the first DNN.

17. A method, comprising:
receiving, by a processor, encrypted traffic generated responsively to a first plurality of actions performed, using a computer application, by one or more users;
classifying the actions, using a classifier, based on statistical properties of the traffic;
identifying, subsequently, that the classifier is misclassifying at least some of the actions that belong to a given class;
automatically labeling, in response to the identifying, a plurality of traffic samples as corresponding to the given class;
retraining the classifier, using the labeled samples;
receiving, subsequently, encrypted traffic generated responsively to a second plurality of actions performed using the computer application;
classifying the second plurality of actions, using the retrained classifier; and
generating an output responsively thereto.

18. The method according to claim 17, wherein the classifier includes an ensemble of lower-level classifiers, and wherein labeling the traffic samples comprises labeling the traffic samples by providing the traffic samples to the lower-level classifiers, such that one or more of the lower-level classifiers labels the traffic samples as corresponding to the given class.

19. The method according to claim 17, wherein labeling the traffic samples comprises:
clustering the traffic samples, along with a plurality of pre-labeled traffic samples that are labeled as corresponding to the given class, into a plurality of clusters, such that at least one of the clusters, which contains at least some of the pre-labeled traffic samples, is labeled as corresponding to the given class, and others of the clusters are unlabeled,
subsequently, identifying those of the unlabeled clusters that are within a given distance from the labeled cluster, and
subsequently, labeling those of the samples that belong to the identified clusters as corresponding to the given class.

20. The method according to claim 17, wherein identifying that the classifier is misclassifying at least some of the actions that belong to the given class comprises identifying that the classifier is misclassifying at least some of the actions that belong to the given class by identifying that one or more statistics, associated with a frequency with which the given class is identified, deviate from historical values.
